(19) United States
(12) Patent Application Publication
(10) Pub. No.: US 2022/0222715 A1
(43) Pub. Date: Jul. 14, 2022

(54) SYSTEM AND METHOD FOR DETECTING AND ANALYZING DISCUSSION POINTS FROM WRITTEN REVIEWS

(71) Applicant: Denis Kazakov, Aurora, CO (US)

(72) Inventor: Denis Kazakov, Aurora, CO (US)

(21) Appl. No.: 17/145,394

(22) Filed: Jan. 10, 2021

(51) Int. Cl. G06Q 30/02; G06Q 10/10; G06F 9/54; G06N 3/08; G06F 40/103

(52) U.S. Cl. CPC G06Q 30/0282; G06Q 30/0201; G06F 40/103; G06F 9/547; G06N 3/08; G06Q 10/10

(57) ABSTRACT

Embodiments of the present invention provide a computer-based system and method for allowing a user to discover and analyze discussion points within a set of customer product reviews. Exemplary embodiments can automatically aggregate customer reviews about products by common discussion points, and can analyze the discovered discussion points in their prevalence, trends over time, customer demographic, and sentiment. Exemplary embodiments enable faster, more automated, and more effective study of customer feedback by the product teams.

### TECHNICAL FIELD OF THE INVENTION

The present invention relates generally to computer systems and processes for analyzing customer experience. More particularly, in one example, the invention relates to a system and method for analyzing written customer feedback in an e-commerce environment, presenting customer feedback data to people responsible for product success and customer satisfaction in an algorithmically organized format, and enabling statistical understanding of customer experiences to improve future product iterations.

### BACKGROUND

People interact daily with a range of products (phone, fridge, car, TV), and services (Amazon marketplace, Etsy, YouTube, internet provider). For simplicity, we refer to both as “products”.

Companies and product development teams are putting their best effort into satisfying their customers and addressing their needs.

Yet as products are used by customers, written customer feedback is often not incorporated effectively. Manual effort is often needed to carefully read through reviews in order to extract meaningful insights.

As a result, written customer feedback is often avoided or not collected altogether by the product teams.

But the process of understanding the customer experience is essential for designers in order to improve product experiences. Not understanding customer feedback means missing an opportunity to improve a product.

Therefore, there is a need for a system and method which allows product teams to effectively investigate and isolate written customer feedback for actionable insights.

### SUMMARY

Exemplary embodiments relate to systems and methods that aid in the analysis of written customer generated feedback, such as product reviews, experience descriptions, comments, and the like. The system aids this goal of extracting discussion points and patterns from a pool of customer feedback, recognizing products discussed, common discussion points, prevalence of those points over time and customer demographic, as well as the general sentiment of discussion points.

In accordance with one exemplary embodiment, a computer executable system is provided for identifying and investigating discussion points in the provided set of reviews. The method includes receiving at a computer system a set of customer reviews to process, processing the reviews at the computer system using a series of machine learning systems and mathematical transformations, resulting in numerical representations of provided reviews, and aggregating numerically represented reviews using another machine learning system that aggregates similar reviews.

In an exemplary embodiment, the set of reviews may be received by the system in a one-off operation.

In an exemplary embodiment, the set of reviews may be received by the system in a continuous, “streaming” fashion; receiving reviews continuously as they come in or in batches (e.g. hourly, daily, etc.).

In an exemplary embodiment, review representations may be provided to the user of the system so that they can integrate it into their own systems.

In an exemplary embodiment, review representations may be aggregated according to a set of parameters given by the user of the system.

In an exemplary embodiment, the computer system may be a web-based application, a piece of software, or an API based service.

In an exemplary embodiment, the system may present a summary of the discussion point.

### BRIEF DESCRIPTION OF THE DRAWINGS

The above and other features and exemplary embodiments of the invention will be more clearly understood from the following detailed description take in conjunction with the accompanying drawings, in which:

FIG. 1 is a diagram showing a high-level relationship between product teams and customers;

FIG. 2 is an exemplary summary of a discussion point identified in an open-source wine review public dataset via an exemplary implementation of the invention.

FIG. 3 Is a table showing an exemplary analysis of a discussion point by demographic, sentiment, time, and size;

FIG. 4 is a flowchart showing an exemplary computer-implemented and computer-executable method for review aggregation and analysis;

### DETAILED DESCRIPTION

The invention and its methods will be made clear from exemplary embodiments described below. The invention may, however, be embodied in other forms and should not be construed as being limited to the exemplary embodiments set forth herein.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal of excessively formal sense unless stated otherwise. Well-known to those skilled in the art constituent elements, operations and techniques are also not described in detail.

Exemplary embodiments address deficiencies of the current customer review analysis. Exemplary embodiments provide systems, and methods for computer-based aggregation of customer reviews into discussion points, as well as providing an analysis of those discussion points.

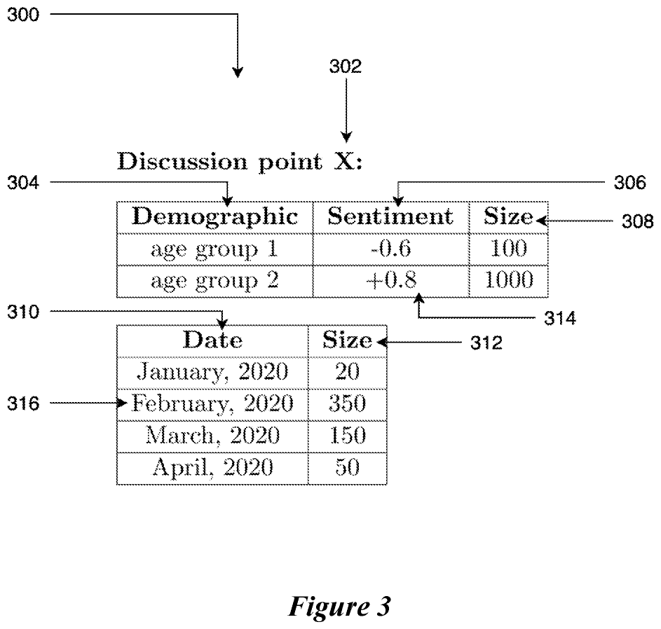

In exemplary embodiments, the discussion point analysis system may include, but is not limited to sentiment analysis 306, demographics analysis 304, time trend analysis 310 as shown by exemplary discussion point analysis in FIG. 3.

In exemplary embodiments, the review aggregation system may include, but is not limited to aggregating reviews by product titles, aggregating by product features, aggregating by the embeddings of reviews.

Because exemplary system 400 allows automatic computer-based customer review processing to detect discussion points and present insights, the system 400 is capable of keeping up with a fast influx of customer-generated reviews 106 that is experienced by popular products 104.

Exemplary embodiments may perform fully automated review processing. In some exemplary embodiments, human input 426 may be used along with automatic computer-based systems to determine desired review aggregation in system 408 and relevant insights to extract in point analysis system 410.

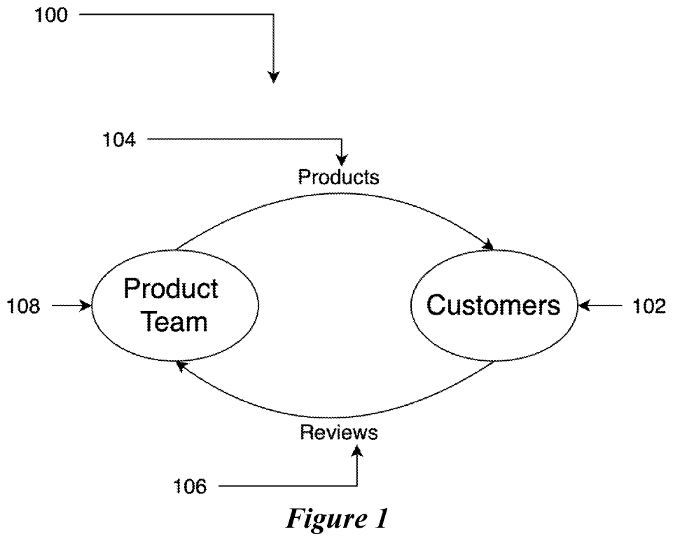

The invention is relevant in a relationship between product teams 108 and customers 102 as is illustrated in drawing 100 on FIG. 1. As customers 102 buy or use products 104, they remark their experiences into reviews 106 that are shared back to the product team 108. Then, the product team 108 may study those reviews 106, in order to improve the next iteration of products 104. This invention helps product teams 108 in their study and analysis of customer reviews 106.

### I. Definitions

The term “set” refers to a collection of one or more items.

The term “discussion point” refers to a common theme or topic present in the given set of reviews. Sometimes only “point” is used instead of “discussion point” for brevity.

The term “product” means a tangible product (e.g. phone, pen, computer), or an experience offered as a service (e.g. Uber transportation service, purchasing experience via a mobile app).

The term “vector” means an ordered set of numbers.

The term “vocabulary” means a complete set of words in the given set of reviews.

The term “representation” or “embedding” means a numerical vector that captures some information about an object (in this case review) it was obtained from.

The term “embed” or “encode” (verb) means converting a given object into its numerical representation. For example, “review embedding” would mean converting a review into its numerical representation.

The term “review” means any written feedback generated by a customer.

The term “customer” means any individual or a group of individuals that is using a product of interest.

The term “product team” means an individual or a group of individuals that is interested in improving customer experience of the product these individuals are providing.

The term “feature” means a functionality of a product. A single product may have multiple features.

The term “cluster” means a set of elements that are close to each other in some embedding space. Typically, each element within a cluster is closer to each other under some element distance measure than to an element outside of a given cluster.

The term “clustering” then means a process of finding cluster assignments for a set of reviews. “Clustering” in plain terms is just aggregation.

The term “distance measure” between review embeddings means a mathematical formula that produces a numerical value for a given pair of review embeddings.

The term “sentiment” refers to a measure of how emotionally positive or negative particular content (e.g. review, group of reviews, discussion point) is.

The term “neural network” is a type of a machine learning model.

### II. Exemplary Embodiments

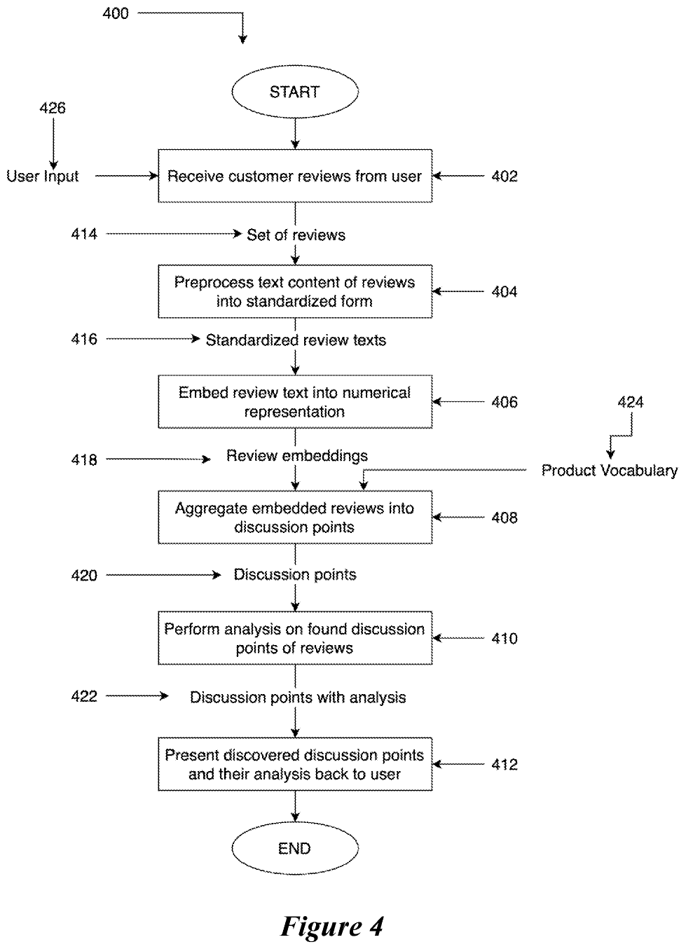

FIG. 4. is a flowchart showing an exemplary computer-implemented and computer-executable method 400 that may automatically discover and analyze discussion points from customer reviews 106. Method 400 follows high-level steps of getting customer reviews to process at step 402, preprocessing text from those reviews at step 404, embeddings the reviews into a numerical representation at step 406 using a machine learning system that captures similarities and differences between reviews into numerical representation, aggregating these numerical representations using a machine learning clustering system at step 408 that groups similar review embeddings together, and finally may perform further analysis on discovered review clusters at step 410 using either basic statistics or more in-depth machine learning system, in order to finally present these findings to the system's user at step 412.

### Exemplary Pre-Processing of Reviews

After obtaining a set of product reviews to investigate at step 402, the method 400 may run an exemplary computer-implemented and computer-executable system for pre-processing reviews in the given set of reviews that may follow the following steps.

In step 404, for each review, the exemplary system may perform any or all, but not limited to the operations of removing stop words, lowercasing all letters, removing special characters from review texts, stemming words within reviews to reduce unique vocabulary size, removing stop words from reviews texts, replacing words with their default synonyms to reduce the vocabulary size even further.

### Exemplary Review Embedding

After reviews are preprocessed at step 404, the method 400 will run an exemplary system for embedding reviews. An exemplary embedding system at step 406 may use term frequency-inverse document frequency (tf-idf) weights for each word in a preprocessed review. Then, each review is converted into a review embedding vector of tf-idf weights of length of unique vocabulary left after preprocessing reviews at step 404. This approach allows us to capture notable and indicative words in text reviews into their review embeddings 418.

Another exemplary embedding system that may run at step 406 may use neural network-based embeddings for review words, where each word gets a numerical vector assigned to it during the training of a neural network model (word2vec). Such system 406 may use open source pretrained word embeddings such as, but not limited to BERT (Bidirectional Encoder Representations from Transformers), or GloVe (Global Vectors for Word Representation). To compute review embeddings 418, system 406 may use an average of all word embeddings in a review as a review embedding. It may alternatively use a pre-trained neural network model to encode the review, such as Universal Sentence Encoder.

Finally, any exemplary system 406 will produce review embeddings 418.

### Exemplary Aggregation of Document Representations to Identify Discussion Points

Once the reviews are embedded by system 406 into numerical vectors 418, an exemplary system 408 to aggregate review embeddings 418 into discussion points 420 may be used. Such system 408 will use a mathematical distance measure and a machine learning clustering method to aggregate review embeddings 418 into discussion points 420.

An exemplary aggregation system 408 may use a variety of mathematical distance measures between embedded reviews 418 for its aggregation step, such as, but not limited to “word mover's distance”, “cosine distance”.

An exemplary aggregation system 408 may further also include a user-provided product vocabulary 424 of product titles, or product features. Then this vocabulary 424 may be used to aggregate reviews by product and product features they refer to. The system may simply use a product vocabulary 424 to compute product vocabulary embeddings of reviews using the same tf-idf embedding as described in system 404.

An exemplary aggregation system then uses a clustering algorithm to aggregate review embeddings 418 together. The system 408 may use “k-means” clustering with an “elbow technique” heuristic used to determine the optimal cluster number k. Discovered “clusters” are exactly the discussion points 420 the system 408 is meant to discover.

### Exemplary Analysis of Discussion Points

Once the system 408 has discovered discussion points 420, an exemplary system 410 for analysis of those points may be run.

An exemplary discussion point analysis system 410 may measure the sentiment of each review within a discussion point cluster to compute an average sentiment 306 as shown in exemplary analysis 300 of discussion point 302 on FIG. 3. Such system 410 may use a neural network model for sentiment classification that produces a sentiment score for a given snippet of text. Sentiment score of each review may be used to provide insights such as, but not limited to “this point is getting significantly more positive reactions from users than any other point” as can be seen in 314.

An exemplary point analysis system 410 may also measure representation of each discussion point across customer demographics 304 to deliver insights such as, but not limited to “younger customers find this product/features more frustrating than older customers”.

An exemplary point analysis system 410 may also measure the size 308 of each discussion point, where size just means a count of such reviews within a given set of reviews.

An exemplary point analysis system 410 may also measure representation 312 of each discussion point over time 310 to deliver insights such as, but not limited to “this point only became significant with the latest release of the product” as is seen in 316.

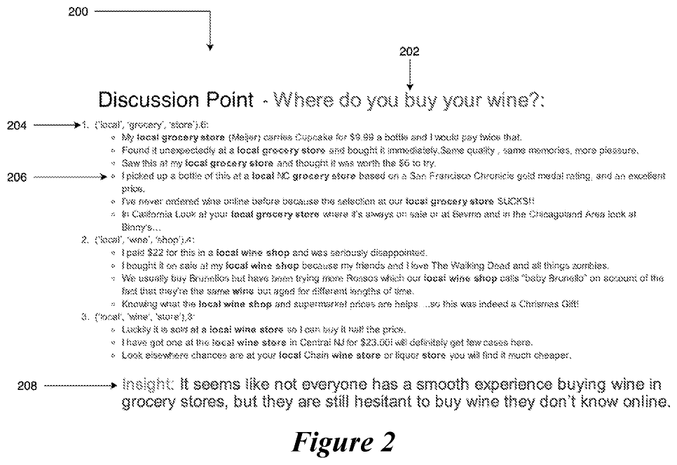

An exemplary point analysis system 410 may also summarize the content of discussion points as is demonstrated by exemplary summary 200 of a point 202 in FIG. 2. Such system may use methods such as, but not limited to 1) presenting a review sample 206 that is maximized in its entropy in the embedded representation space, 2) presenting reviews that are the most central to their review cluster in the embedded representation space, 3) presenting keywords 204 associated with a discussion point 202, 4) presenting a summary 208 of the analysis of the discussion point 202.

1. Computer executable system for discovering discussion points in a given set of customer reviews about a product or products, the system comprising:
receiving customer reviews;
preprocessing customer reviews using a computer-executable system;
embedding reviews into their numerical representation using a computer-executable system that produces numerical representations of reviews, distances between which capture relative similarity between reviews;
aggregating reviews into discussion points using a machine learning algorithm that clusters together reviews that are similar in their embedding under some mathematical distance measure.

2. The method of claim 1, wherein the method also performs analysis on the discussion points.

3. The method of claim 2, wherein the discussion point analysis is measuring the prevalence of discussion points over time, over customer demographics, as well as measuring the general sentiment of discussion points.

4. The method of claim 1, wherein customer reviews are received in a one-off operation.

5. The method of claim 1, wherein customer reviews are received in a continuous streaming fashion.

6. The method of claim 1, wherein embedding of customer reviews is done in a manner than iteratively reduces the dimensionality of the review set through aggregating reviews by products or product features, through aggregating reviews by discussion points, through aggregating reviews by sentiment, customer demographics, and time.

7. The method of claim 1, wherein aggregation of customer reviews is done using parameters provided by the user of the system.

8. The method of claim 1, wherein the computer-executable system is running as a web-based application.

9. The method of claim 1, wherein the computer-executable system is running as an API-based service.

10. The method of claim 1, wherein the computer-executable system is running as a standalone software application.

11. The method of claim 1, wherein the additional analysis of discussion points presents a summarized view of the discussion points.
